(19) United States
(12) Patent Application Publication
(10) Pub. No.: US 2003/0151874 A1
(43) Pub. Date: Aug. 14, 2003

(54) Bi-level voltage surge protection

(76) Inventor: Richard E. Shipp, Westminster, CA (US)

Correspondence Address: John H. Lynn, Suite F 200, 2915 Redhill Avenue, Costa Mesa, CA, 92626, US

(21) Appl. No.: 10/072,699

(22) Filed: Feb. 8, 2002

(51) Int. Cl. H02H 9/06

(52) U.S. Cl. 361/126; 361/117

(57) ABSTRACT

A stand-alone voltage surge suppression device for use with household appliances is arranged for connection to conventional female wall type outlets. The device is made to plug into an outlet socket and protect the adjacent sockets. The surge components of the device include two sets of varistors and thermofuses. In this embodiment, there are two sets of varistors and thermofuses. One is a primary varistor and fuse combination set at a lower voltage, and the other is a secondary group set at a higher voltage. Both take effect in surge protection, however, with enough hits, the lower one will fail first. Even so, the secondary group will still provide sufficient, although reduced amount of protection. In order for the user to know the status of the unit, there are two indicator lamps on the outside of the device. The surge protector preferably includes a light source arranged to indicate when the primary pair of varistors stops functioning. The surge protector may further include a first light source arranged to indicate when the primary pair of varistors stops functioning and a second light source arranged to indicate when the secondary pair of varistors stops functioning.

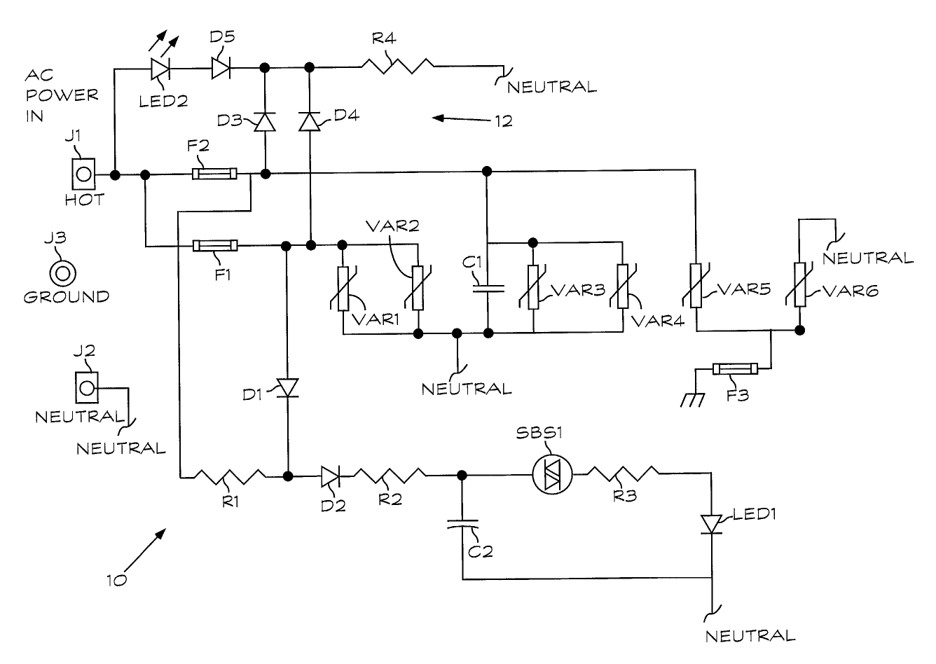

### BACKGROUND OF THE INVENTION

This invention relates to electrical protection devices and particularly to voltage surge suppression for protecting electrical home appliances such as video, audio and telephone equipment that could receive voltage surges or transients from an electrical power line.

Most electrical appliances are connected to an electrical power line through a wall plate without any protection against surges that have the capacity to do serious damage. Generally, the only safety feature in the circuit will be a fuse or circuit breaker. These devices are intended to open up when a sustained current overload occurs on their respective power line. Many times, this will be too late to help against a fast overload that happens and goes away before tripping a circuit breaker or fuse. These overloads can be caused by lightning strikes near the facility, thereby putting into jeopardy the appliances connected to the power line.

Devices can be attached to the power line to protect electrical appliances from surges. Such devices fall into two categories: (1) devices that are in-line with the appliance (a series connection) and place themselves between the power line and the unit they are to protect, and (2) devices that are across the power line (a parallel connection) and protect the units on adjacent sockets by suppressing the surges directly. Both have their respective advantages. In-line units can be made that prevent large surges from reaching the appliance, but they require the capability of being placed in a series connection.

The types of components currently being used in surge suppression include gas discharge tubes, transient surge suppressors, inductors, capacitors, and Metal Oxide Varistors(MOVs). For power line applications, MOVs are used extensively.

Metal Oxide Varistors(MOVs) are devices that start clamping the voltage placed across them at a specified level. This level is set to be greater than the normal power line voltage, such that when it is placed across a power line, it will not clamp until a transient occurs. As the transient increases, the MOV will increase current flow through itself to prevent the transient voltage from rising further. Depending on the value of the transient voltage and the line impedance, up to several thousand amps can be shunted through the MOV. Although MOVs can handle currents of this magnitude, they can do so only for a limited number of times before the device fails. And, when an MOV fails, it could do so as a short circuit, which could in turn lead to significant current drain on the line and overheating of the failed device. To prevent this, a fuse can be placed in series with the MOV. This could be a regular fuse that senses a long duration of excessive current. Another approach is to use a thermal cutoff fuse that senses the heat build up and opens permanently. In either case, the MOV is disconnected from the power line, and will no longer provide surge protection.

While many surge protection devices using MOVs are on the market, there are several disadvantages in the devices. Many have no way of telling the user that they are working at all, and if the device fails, the user is completely unaware of it. None have any way of applying secondary protection, when the fuse opens.

### SUMMARY OF THE INVENTION

The present invention is a stand-alone voltage surge suppression device for use with household appliances connected to the conventional female wall type outlets. The device is made to plug into an outlet socket and protect the ones that are adjacent to it. It has two male prongs that extend from the back of the unit and connect to the female power receptacle. There is a grounding prong that extends from the back of the unit and connects to the grounding female contact of the wall outlet. The surge components of the device consist of a varistor and thermofuse connected in series across the power line. They are tied thermodynamically by being in close proximity and being taped together.

When there is a specified surge or spike voltage above the normal line values, this increased voltage will turn on the varistor. Its resistance is greatly reduced, causing the current to be bypassed away from the connected load. After the surge or spike is gone, the varistor returns to its off state. The connected load is provided protection from these short-term conditions. If the varistor fails by shorting out, the heat generated will cause the thermofuse to open. The fuse does not reset when the condition is removed and the line is no longer protected.

In this embodiment, there are two sets of varistors and thermofuses. One is a primary varistor and fuse combination set at a lower voltage, and the other is a secondary group set at a higher voltage. Both take effect in surge protection, however, with enough hits, the lower one will fail first. Even so, the secondary group will still provide sufficient, although reduced amount of protection. In order for the user to know the status of the unit, there are two indicator lamps on the outside of the device. There is a green indicator lamp that is on all the time when both primary and secondary protection is in place. If the primary group is gone, the green lamp will change from being on all the time to a slow flashing light. This tells the user that there is still protection for the connected load, but this device should be replaced. If the secondary group is lost, another red indicator lamp will turn on. This, of course, tells the user that there is no longer any surge protection available.

The surge protector preferably includes a light source arranged to indicate when the primary pair of varistors stops functioning. The surge protector may further include a first light source arranged to indicate when the primary pair of varistors stops functioning and a second light source arranged to indicate when the secondary pair of varistors stops functioning.

An appreciation of the objectives of the present invention and a more complete understanding of its operation may be obtained by studying the description of the preferred embodiment and referring to the accompanying drawing.

### BRIEF DESCRIPTION OF THE DRAWING

The FIGURE is a schematic diagram of the circuitry that may be included in the surge protection device according to the invention.

### DETAILED DESCRIPTION OF THE INVENTION

Referring to the FIGURE, a surge protector 10 according to the invention includes a hot side connector J1 that provides a connection between a hot terminal of wall socket (not shown) and a circuit board (not shown) upon which the surge protection circuitry is placed. A neutral side connector J2 provides a connection from the neutral terminal of the wall plate receptacle to the circuit board. The surge protector 10 normally will also include a ground prong connector J3 (normally U-shaped) from the wall plate receptacle to the circuit board.

A primary varistor group 14 that includes a pair of hot side varistors VAR1 and VAR2 provides protection at lower voltages. A thermofuse F1 is connected between the hot side connector J1 to the varistors VAR1 and VAR2, which are connected in parallel from the fuse F1 to neutral. All the excessive current from a surge is shunted to neutral through this path. If either of the varistors VAR1 or VAR2 fails by shorting out, the excessive current and heat build up will open the fuse F1. The fuse F1 is not resettable, thus rendering the primary varistor group 14 unusable.

The surge protector 10 also includes a secondary varistor group 16 that includes a pair of secondary varistors VAR3 and VAR4 arranged to provide protection at a higher voltage level. The primary varistors VAR1 and VAR2 will take more of the surge than the secondary varistors VAR3 and VAR4.

A thermofuse F2 is connected between the hot side connector J1 to the varistors VAR3 and VAR4. The varistors VAR3 and VAR4 are the higher voltage varistors. They are connected in parallel from the fuse F1 to neutral. All the excessive current from a surge is shunted to neutral through this path. These will take less of the surge than the primary varistors. If either of the varistors VAR3 or VAR4 fails by shorting out, the excessive current and heat build up will open the fuse F2. The fuse F2 also is not resettable thus rendering the secondary varistor group unusable.

A capacitor C1 is connected in parallel with varistors the VAR3 and VAR4. The capacitor C1 helps filter high frequencies that are on the power line.

A pair of ground varistors VAR5 and VAR6 provides protection from hot to ground and neutral to ground. A thermofuse F3 is connected between the junction of the varistors VAR5 and VAR6 and the ground terminal. The varistor VAR5 is connected between the thermofuse F2 to the thermofuse F3 to protect the circuit from the hot-to-ground condition. The varistor VAR6 is connected between neutral to the thermofuse F3 to protect the circuit from the neutral-to-ground condition. The varistor VAR5 is located beyond the secondary group thermofuse F2 so that if the varistor VAR6 shorts out and opens the thermofuse F3, the varistor VAR5 is still fused through the fuse F2. There is no unfused path from hot-to-neutral.

The surge protector 10 preferably includes an indicator LED1 that will be on continuously, slow flashing or off, depending on the charging current input to a timing capacitor C2.

A resistor R1 is connected between the thermofuse F2 and the junction of a pair of diodes D1 and D2. The diode D1 is also connected to the thermofuse F1. A resistor R2 is connected between the diode D2 and the timing capacitor C2. The sum of the resistances of the resistors R1 and R2 sets the slow flashing time of the LED1 by decreasing the current to the timing capacitor C2. When the thermofuse F1 opens, there is no longer any current for the LED circuit.

The resistor R2 sets the continuous flashing of the LED1 long as it gets its current directly through the thermofuse F1.

The diode D1 provides a current path around the resistor R1 as long as the thermofuse F1 is a short. Once the thermofuse F1 opens, then the charging current has to go through the resistor R1.

The diode D2 is a blocking diode from the junction of the resistor R1 and the diode D1 to the timing capacitor C2 that prevents the timing capacitor C2 from losing charge during the negative half cycle of the power line sine wave.

The timing capacitor C2 is connected between the junction of the resistor R2 and SBS1 to neutral for the status indication circuit. The timing capacitor C2 is charged through either the resistor R2 (fast) or through the resistor R2 and R1 (slow). When it reaches a specified voltage, a diac SBS1 will break over, allowing current to light the LED1. If both of the thermofuses F1 and F2 are open, then there will be no charging current such that the LED 1 will remain off.

The diac SBS 1 is a bilinear diac connected between the junction of the capacitor C2 and the resistor R2 and the resistor R3. The diac SBS1 remains off until the timing capacitor C2 charges to the break over voltage of the diac SBS1. At this point, the diac SBS1 allows a pulse of current to go to the LED circuit while it discharges the timing capacitor C2. Normally, there would be a current pulse approximately every positive cycle of the power line sine wave, causing the LED1 to appear to be on continuously. If the thermofuse F1 becomes open (loss of the primary group) the charging current will be through the resistor R1. The flashing of LED1 will now be much slower.

A resistor R3 is connected between the diac SBS1 to and the LED1 to limit current to the LED1

The LED1 is normally a green LED connected between the resistor R3 and neutral. The LED1 normally is either continuously flashing (current from resistor the R2), slow flashing (current from the resistor R1 plus the resistor R2), or off when both thermofuses F1 and F2 are open.

The surge protector 10 also preferably includes a No protection Indicator circuit 12, which preferably includes a red indicator LED2 that is normally off, unless the protection circuits are completely gone. The LED2 then is on continuously.

A current steering diode D3 is connected between the fuse F2 and the junction of a diode D5 and a resistor R4. A current steering diode D4 is connected between the fuse F1 and the junction of the diode D5 and a resistor R4. As long as one of the thermofuses F1 and F2 are shorted, they provide current for the resistor R4, thus keeping LED2 off.

The diode D5 serves as a blocking diode to keep voltage off LED2 during the negative half cycle of the power line sinewave. The diode D5 also insures that there is no voltage drop across the LED2 when either of the diodes D3 or D4 is conducting during the positive half cycle.

The LED2 is normally a red LED connected between the hot side of the power line and the diode D5. As stated above, it is off unless both thermofuses F1 and F2 have opened.

A resistor R4 is connected between the junction of the diodes D5, D3, and D4 to neutral. The resistor R4 provides the current for the LED2 when there is no protection left.

The structures and methods disclosed herein illustrate the principles of the present invention. The invention may be embodied in other specific forms without departing from its spirit or essential characteristics. The described embodiments are to be considered in all respects as exemplary and illustrative rather than restrictive. Therefore, the appended claims rather than the foregoing description define the scope of the invention. All modifications to the embodiments described herein that come within the meaning and range of equivalence of the claims are embraced within the scope of the invention.

What is claimed is:

1. A surge protector for protecting an electrical appliance that is connected to an electrical power line, comprising:
a first thermofuse connected to the power line;
a primary pair of varistors connected in parallel between the first thermofuse and neutral;
a second thermofuse connected to the power line; and
a secondary pair of varistors connected in parallel between the second thermofuse and neutral.

2. The surge protector of claim 1 further comprising a capacitor connected in parallel with the secondary pair of varistors.

3. The surge protector of claim 1 further comprising:
a third thermofuse having a first terminal connected to ground;
a first ground varistor connected between the second thermofuse and a second terminal of the third thermofuse to provide protection from hot to ground short circuits;
a second ground varistor connected between neutral and the third thermofuse to provide protection from neutral to ground short circuits.

4. The surge protector of claim 1, further comprising a light source arranged to indicate when the primary pair of varistors stops functioning.

5. The surge protector of claim 1, further comprising:
a first light source arranged to indicate when the primary pair of varistors stops functioning; and
a second light source arranged to indicate when the both the primary and secondary pair of varistors stop functioning.
